(19) United States
(12) Patent Application Publication
(10) Pub. No.: US 2010/0055460 A1
(43) Pub. Date: Mar. 4, 2010

(54) HIGHLY DISPERSIBLE FINE POWDER OF ALKALINE EARTH METAL CARBONATE AND PROCESS FOR PRODUCING THE SAME

(75) Inventors: Yojiro Ichimura, Yamaguchi (JP); Takashi Watanabe, Yamaguchi (JP); Fumio Okada, Yamaguchi (JP); Naoki Funabashi, Yamaguchi (JP)

Correspondence Address: NIXON PEABODY, LLP, 401 9TH STREET, NW, SUITE 900, WASHINGTON, DC, 20004-2128, US

(73) Assignee: UBE MATERIAL INDUSTRIES, LTD., Ube-shi, Yamaguchi (JP)

(21) Appl. No.: 12/530,936

(22) PCT Filed: Mar. 12, 2008
(86) PCT No.: PCT/JP2008/054499

§ 371 Date: Sep. 11, 2009

(30) Foreign Application Priority Data
Mar. 13, 2007 (JP) 2007-063765
Mar. 28, 2007 (JP) 2007-085119

(51) Int. Cl. B32B 5/16; C01F 11/18

(52) U.S. Cl. 428/402; 423/430; 423/432

(57) ABSTRACT

A fine alkaline earth metal carbonate powder showing high dispersibility, in which the alkaline earth metal carbonate is selected from the group consisting of strontium carbonate and barium carbonate, can be prepared by a process comprising the steps of pulverizing a powder of strontium carbonate or barium carbonate in an aqueous medium using ceramic beads having a mean diameter of 10 to 1,000 μm in the presence of a polymer comprising a polycarboxylic acid or anhydride thereof having a side chain of a polyoxyalkylene group, and drying the pulverized powder.

### FIELD OF THE INVENTION

The present invention relates to a fine alkaline earth metal carbonate powder showing high dispersibility in an aqueous medium, in which the alkaline earth metal carbonate is selected from the group consisting of strontium carbonate and barium carbonate, and a process for preparing the same.

### BACKGROUND OF THE INVENTION

An alkaline earth metal carbonate powder such as a strontium carbonate powder or a barium carbonate powder can be employed for preparing a dielectric ceramic powder. The dielectric ceramic powder is utilized for producing a dielectric ceramic layer of a multilayer ceramic capacitor.

Since it is required to provide an electronic device with a smaller size, a multilayer ceramic capacitor is required to have a smaller size. In order to manufacture a multilayer ceramic capacitor having a smaller size, a dielectric ceramic layer should have a less thickness. In order to produce a dielectric ceramic layer having a less thickness, it is required to provide a fine dielectric ceramic powder having a uniform composition.

For the purpose of preparing a fine dielectric ceramic powder (such as a strontium titanate powder or a barium titanate powder) having a uniform composition, it is necessary to prepare a fine strontium carbonate powder, a fine barium carbonate powder, and a fine titanium dioxide powder. In consideration of the necessity of the fine powders, processes for preparing a fine strontium carbonate powder, a fine barium carbonate powder, and a fine titanium dioxide powder have been studied, and already disclosed in the following patent publications.

Patent Publication 1 (Japanese Patent Provisional Publication (Tokuhyohei) 11-514961) discloses a process for preparing a fine alkaline earth metal carbonate powder which comprises the steps of introducing gaseous carbon dioxide into an aqueous alkaline earth hydroxide solution preferably in the presence of a crystalline growth-inhibitor selected from a group consisting of an ammonium salt of a specific carboxylic acid and an alkyl-ammonium salt of a specific carboxylic acid to produce alkaline earth metal carbonate particles, applying shearing force and friction to the produced alkaline earth carbonate particles at a relatively high rate in a homogenizer under high working pressure, recovering thus treated particles, and drying the recovered particles. Patent Publication 1 describes that the process gives a fine strontium carbonate powder having a BET specific surface area of 3 to 50 m²/g and comprising at least 90% of a powder having a diameter of 0.1 to 1.0 μm, preferably a diameter of 0.2 to 1.0 μm, and a fine barium carbonate powder having a BET specific surface area of 3 to 30 m²/g, preferably 3 to 20 m²/g, more preferably 8 to 15 m²/g, and comprising at least 90% of a powder having a diameter of 0.2 to 0.7 μm. Examples of the crystalline growth-inhibitors are described to include ammonium salts and alkylammonium salts of citric acid, malic acid, adipic acid, gluconic acid, glucaric acid, glucuronic acid, tartaric acid and maleic acid.

Patent Publication 2 (Japanese Patent Provisional Publication 2004-59372) discloses a process for preparing a fine barium carbonate powder which comprises processing a mixture of a barium carbonate slurry and a granular medium in a fluid condition at a high rate, preferably in the presence of a particle growth-inhibitor such as a polyhydric alcohol, ascorbic acid, pyrophosphoric acid, carboxylic acid, or carboxylate. Patent Publication 2 describes that the disclosed process can give a barium carbonate powder having a BET specific surface area of 5 to 50 m²/g and a mean diameter (determined by a laser diffraction method) of 0.01 to 1.0 μm. Examples of the carboxylic acids and carboxylates employable as the particle growth-inhibitor are described to include citric acid, carboxymethylcellulose, oxalic acid, malonic acid, succinic acid, malic acid, maleic acid, tartaric acid, adipic acid, acrylic acid, polycarboxylic acid, polyacrylic acid, and their salts with sodium or ammonium.

Patent Publication 3 (Japanese Patent Provisional Publication 11-1321) discloses a process for preparing a fine titanium dioxide powder which comprises the steps of dissolving titanyl sulfate in a mixture of water and an alcohol and heating the resulting solution under reflux. Patent Publication 3 describes that the disclosed process can give a titanium dioxide powder having a mean diameter of a nano order (in the range of 5.5 to 12.0 nm).

As is described hereinbefore, it is necessary to prepare fine ceramic materials such as a fine strontium carbonate powder, a fine barium carbonate powder, and a fine titanium dioxide powder for producing a fine dielectric ceramic powder such as a fine strontium titanate powder or a fine barium titanate powder.

Generally, the dielectric ceramic powder is produced in industry by mixing the starting material powders under wet conditions. Therefore, it is preferred that the starting material powders can be dispersed in an aqueous medium to give a dispersion containing essentially primary particles by means of industrially employable dispersing procedures.

As is described above, it has been known that a very fine titanium dioxide powder can be prepared. However, the strontium carbonate powder and barium carbonate powder disclosed in Patent Publication 1 have a relatively large particle diameter.

Further, as is described in Patent Publication 2, a very fine barium carbonate powder can be obtained by pulverizing a barium carbonate powder in an aqueous medium utilizing a granular medium. There is problem, however, in that a dried powder is firmly aggregated due to van der Waals force and not easily re-dispersed in an aqueous solvent to give a dispersion containing the very fine powder, if the obtained fine barium carbonate powder in an aqueous medium is once dried.

### SUMMARY OF THE INVENTION

Accordingly, it is an object of the invention to provide a highly dispersible fine strontium carbonate powder or barium carbonate powder which is finer than the known strontium carbonate powder or barium carbonate powder and which can be dispersed in an aqueous medium by industrially employable dispersing procedures to give a dispersion containing essentially primary particles.

The inventors have discovered that a fine alkaline earth metal carbonate powder (i.e., fine powder of strontium carbonate or barium carbonate) whose primary particles are very fine and which can be well dispersed in an aqueous medium can be obtained by pulverizing a alkaline earth metal carbonate powder in an aqueous medium using ceramic beads having a mean diameter of 10 to 1,000 μm in the presence of a polymer comprising a polycarboxylic acid or anhydride thereof having a side chain of a polyoxyalkylene group.

Accordingly, the present invention resides in a process for preparing a fine alkaline earth metal carbonate powder showing high dispersibility, the alkaline earth metal carbonate being selected from the group consisting of strontium carbonate and barium carbonate, which comprises the steps of pulverizing a powder of strontium carbonate or barium carbonate in an aqueous medium using ceramic beads having a mean diameter of 10 to 1,000 μm in the presence of a polymer comprising a polycarboxylic acid or anhydride thereof having a side chain of a polyoxyalkylene group, and drying the pulverized powder.

Preferred embodiments of the above-mentioned preparation process according to the invention are described below.

(1) The polymer comprises a polycarboxylic acid anhydride having a side chain of a polyoxyalkylene group.

(2) The polycarboxylic acid anhydride of (1) above is a maleic anhydride polymer.

(3) The alkaline earth metal carbonate powder is a strontium carbonate powder which is prepared by supplying gaseous carbon dioxide into an aqueous solution or dispersion containing strontium hydroxide in an amount of 1 to 20 wt. % and an organic acid or a salt thereof in an amount of 0.012 to 24 wt. % based on the amount of strontium hydroxide, under stirring at a temperature of 2 to 100° C., at a supply rate of 0.5 to 200 mL/min., per 1 g of the strontium hydroxide, whereby carbonatating the strontium hydroxide to produce the strontium carbonate powder.

(4) The alkaline earth metal carbonate powder is a barium carbonate powder which is prepared by supplying gaseous carbon dioxide into an aqueous dispersion containing barium hydroxide in an amount of 3 to 20 wt. % and an citric acid in an amount of 3.5 to 12 wt. % based on the amount of barium hydroxide under stirring at a temperature of 5 to 15° C., at a supply rate of 0.5 to 20 mL/min., per 1 g of the barium hydroxide, whereby carbonatating the barium hydroxide to produce the barium carbonate powder.

The invention further resides in a fine strontium carbonate powder showing high dispersibility which has a polymer comprising a polycarboxylic acid or anhydride thereof having a side chain of a polyoxyalkylene group attached to a surface thereof, in which a primary particle of the powder has a mean diameter of 30 to 90 nm, the mean diameter being measured on a circle obtained from a projected area of a primary particle, and in which a variation coefficient of the mean diameter is not more than 40%.

Preferred embodiments of the highly dispersible fine strontium carbonate powder according to the invention are described below.

(1) The mean diameter is in the range of 40 to 80 nm.

(2) The variation coefficient of the mean diameter is not more than 35%.

(3) A mean value of an aspect ratio of the primary particle is not more than 2.

(4) The fine strontium carbonate powder has a volume-based mean diameter of not more than 120 nm, in which volume-based mean diameter can be determined in a dispersion which is prepared by placing 0.2 g of the powder in 20 mL of an aqueous solution containing 0.2 wt. % of sodium hexamethaphosphate and dispersing the powder in the solution for 6 minutes by means of a ultrasonic homogenizer at a power of 17 W according to a dynamic light-scattering method.

The invention furthermore resides in a fine barium carbonate powder showing high dispersibility which has a polymer comprising a polycarboxylic acid or anhydride thereof having a side chain of a polyoxyalkylene group attached to a surface thereof, which has a BET specific surface area of not less than 30 m²/g, in which a primary particle of the powder has a mean diameter of 5 to 50 nm, the mean diameter being measured on a circle obtained from a projected area of a primary particle, and in which a variation coefficient of the mean diameter is not more than 40%.

Preferred embodiments of the highly dispersible fine barium carbonate powder according to the invention are described below.

(1) The BET specific surface area is in the range of 30 to 50 m²/g.

(2) A mean value of an aspect ratio of the primary particle is not more than 2.

(3) A volume-based mean particle diameter is not more than 0.5 μm and a content of particles having a particle diameter of 1 μm or more is not more than 10 vol. %, in which the volume-based mean particle diameter is obtainable from a volume-based particle diameter distribution which is determined in a dispersion prepared by placing 0.5 g of the powder in 50 mL of an aqueous solution containing 0.2 wt. % of sodium hexamethaphosphate and dispersing the powder in the solution for 5 minutes by means of an ultrasonic homogenizer at a power of 80 W according to a laser diffraction-scattering method.

(4) A dispersion prepared by placing 0.5 g of the powder in 50 mL of an aqueous solution containing 0.2 wt. % of sodium hexamethaphosphate and dispersing the powder in the solution for 5 minutes by means of a ultrasonic homogenizer at a power of 80 W shows an absorbance of 1.00 or less at a wavelength of 600 nm.

### EFFECTS OF THE INVENTION

The process of the invention for preparing a fine alkaline earth metal carbonate powder showing high dispersibility can give a fine alkaline earth metal carbonate powder which is highly dispersible in an aqueous medium in industrially employable procedures.

The fine strontium carbonate powder and fine barium carbonate powder which are obtainable by the process of the invention are finer than the known strontium carbonate powder and barium carbonate powder and can be dispersed in an aqueous medium employing industrially employable dispersing procedures to give a dispersion containing essentially primary particles, Therefore, the fine strontium carbonate powder or fine barium carbonate powder can be easily mixed with other fine inorganic material powder to give a uniform powdery mixture by means of wet-mixing procedures.

### PREFERRED EMBODIMENTS OF THE INVENTION

The process of the invention for preparing a fine alkaline earth metal carbonate powder showing high dispersibility can be performed by the steps of pulverizing a powder of strontium carbonate or barium carbonate in an aqueous medium using ceramic beads having a mean diameter of 10 to 1,000 μm in the presence of a polymer comprising a polycarboxylic acid or anhydride thereof having a side chain of a polyoxyalkylene group, and drying the pulverized powder.

The pulverization of the alkaline earth metal carbonate powder in the presence of a polymer comprising a polycarboxylic acid or anhydride thereof having a side chain of a polyoxyalkylene group gives a fine alkaline earth metal powder having the polymer attached onto its surface. The fine alkaline earth metal powder having the polymer on its surface shows increased dispersibility in an aqueous medium because the side chain of a polyoxyalkylene group is hydrophilic.

The attachment of the polymer onto the surface of the fine alkaline earth metal powder can be determined by obtaining an IR spectrum on the surface of the fine powder by means of FT-IR (Fourier Transformation InfraRed Spectro Photometer).

An aqueous dispersion of the alkaline earth metal carbonate powder for the use in the pulverization preferably is an aqueous dispersion containing 5 to 40 wt. % of the alkaline earth metal powder (i.e., solid content) in an aqueous medium. The amount of the solid content is determined based on the amount of the aqueous medium and solid content.

The polymer comprising a polycarboxylic acid or anhydride thereof having a side chain of a polyoxyalkylene group preferably is a polycarboxylic acid anhydride having a side chain of a polyoxyalkylene group. The polycarboxylic acid anhydride preferably is a maleic anhydride polymer. The polycarboxylic acid anhydride having a side chain of a polyoxyalkylene group is commercially available, for instance, from Nippon Oil and Fat Co., Ltd. under trade names of MARIARIM AKM-0531, MARIARIM AKM-1511-60, MARIARIM HKM-50A and MARIARIM HKM-150A.

The polymer comprising a polycarboxylic acid or anhydride thereof having a side chain of a polyoxyalkylene group is preferably added in an amount of 0.5 to 20 wt. %, more preferably in an amount of 1 to 10 wt. %, based on the solid content of the alkaline earth metal.

The ceramic beads can be known beads for pulverizing procedures, for instance, zirconium oxide beads and aluminum oxide beads. The beads preferably has a mean particle diameter in the range of 30 to 500 μm.

The pulverizing apparatus can be a known media mill employable for pulverization of ordinary particles. The pulverization in a media mill can be performed using a beads stirring paddle which rotates at a circumferential speed in the range of 3 to 15 m/min., preferably 5 to 9 m/min.

The pulverization can be performed for a period of 1 to 200 minutes (period for processing in the mill), preferably 10 to 100 minutes, which depends on the alkaline earth metal carbonate content in the aqueous alkaline earth metal carbonate dispersion and the mean diameter of the ceramic beads. The polymer comprising a polycarboxylic acid or anhydride thereof having a side chain of a polyoxyalkylene group can be added to the an aqueous alkaline earth metal dispersion before start of pulverization or in the course of pulverization.

The pulverized aqueous alkaline earth metal carbonate dispersion can be dried using known dryers, preferably a spray dryer or a drum dryer.

The alkaline earth metal carbonate powder can be prepared, for example, by carbonatiating an alkaline earth metal hydroxide by introducing gaseous carbon dioxide into an aqueous alkaline earth metal hydroxide solution or an aqueous alkaline earth metal hydroxide dispersion under stirring, to give an alkaline earth metal carbonate particles. The alkaline earth metal carbonate particles can be then recovered from the aqueous dispersion by a known procedure such as filtration, decantation, or centrifugal separation, washed with water, and dried to give the desired powder. Alternatively, the dispersion can be directly spray-dried.

The dispersion of the alkaline earth metal carbonate particles obtained by the carbonatation of an alkaline earth metal hydroxide in an aqueous medium can be as such employed for the pulverization with no processing or after it is concentrated. Alternatively, the prepared aqueous alkaline earth metal carbonate dispersion can be once dried to give an alkaline earth metal carbonate powder, and then the resulting powder can be re-dispersed in an aqueous media to give an alkaline earth metal carbonate powder for pulverization.

In the case where the alkaline earth metal carbonate powder is a strontium carbonate powder, the strontium carbonate powder is preferably prepared by supplying gaseous carbon dioxide into an aqueous solution or dispersion containing strontium hydroxide in an amount of 1 to 20 wt. % and an organic acid or a salt thereof in an amount of 0.012 to 24 wt. % based on the amount of strontium hydroxide (that is, 0.01 to 20 wt. % based on the amount of the produced strontium carbonate), under stirring at a temperature of 2 to 100° C., at a supply rate of 0.5 to 200 mL/min., per 1 g of the strontium hydroxide, whereby carbonatiating the strontium hydroxide to give a strontium carbonate powder.

The aqueous solution or dispersion of strontium hydroxide preferably contains the strontium hydroxide in an amount of 2 to 10 wt. %, per the amount of the aqueous solution or dispersion.

The organic acid or a salt thereof can serve as a particle growth-inhibitor for inhibiting growth of produced strontium carbonate particles. The organic acid or a salt thereof can be a carboxylic acid, a carboxylate, or an ascorbic acid. Examples of the carboxylic acid include oxalic acid, succinic acid, malonic acid, citric acid, malic acid, adipic acid, gluconic acid, glucaric acid, glucuronic acid, tartaric acid and maleic acid. Examples of the carboxylates include their salts of magnesium, calcium, strontium and barium. The organic acid and a salt thereof preferably is a carboxylic acid or ascorbic acid. Citric acid is most preferred. The organic acid or a salt thereof can be added in an amount preferably in the range of 0.012 to 2.4 wt. % based on the amount of strontium hydroxide (that is, 0.01 to 2 wt. % based on the amount of the produced strontium carbonate).

The gaseous carbon dioxide is fed into the aqueous strontium hydroxide solution or dispersion at a feed rate of 0.5 to 100 mL/min., per one gram of the strontium hydroxide in the aqueous solution or dispersion. The gaseous carbon dioxide can be fed into the aqueous solution or dispersion alone or with an inert gas (inert to strontium hydroxide) such as nitrogen, argon, oxygen or air. The completion of carbonatation of strontium hydroxide can be determined at a time when the dispersion reaches pH 7 or less.

The carbonatation of strontium hydroxide in the aqueous solution or dispersion is preferably performed at a temperature of 5 to 100° C., more preferably 5 to 50° C.

The primary particle of the strontium carbonate obtained in the above-described manner is cubic, globular or acicular. The size (i.e., mean diameter being measured on a circle obtained from a projected area of a primary particle) of the primary particle can be more than 90 nm.

In the case where the alkaline earth metal carbonate powder is a barium carbonate powder, the barium carbonate powder is preferably prepared by supplying gaseous carbon dioxide into an aqueous dispersion containing barium hydroxide in an amount of 3 to 20 wt. % and an citric acid in an amount of 3.5 to 12 wt. % based on the amount of barium hydroxide (that is, 3 to 10 wt. % based on the amount of the produced barium carbonate), under stirring at a temperature of 5 to 15° C., at a supply rate of 0.5 to 20 mL/min., per 1 g of the barium hydroxide, whereby carbonatiating the barium hydroxide to produce the barium carbonate powder.

The concentration of barium hydroxide in the aqueous barium hydroxide dispersion preferably is in the range of 3 to 10 wt. %. The citric acid is preferably added to the aqueous dispersion in an amount of 3.5 to 8 wt. % based on the amount of barium hydroxide (i.e., 3 to 7 wt. % based on the amount of the produced barium carbonate).

The gaseous carbon dioxide is fed into the aqueous barium hydroxide solution or dispersion at a feed rate of 0.5 to 10 mL/min., per one gram of the barium hydroxide in the aqueous solution or dispersion. The gaseous carbon dioxide can be fed into the aqueous solution or dispersion alone or with an inert gas (inert to barium hydroxide) such as nitrogen, argon, oxygen or air. The completion of carbonatation of strontium hydroxide can be determined at a time when the dispersion reaches pH 7 or less.

The barium carbonate powder obtained above generally is a powder having a BET specific surface area of 30 m²/g or more.

The fine strontium carbonate powder of the invention generally has a polymer comprising a polycarboxylic acid or anhydride thereof having a side chain of a polyoxyalkylene group attached to its surface, in which a primary particle of the powder has a mean diameter of 30 to 90 nm, the mean diameter being measured on a circle obtained from a projected area of a primary particle, and in which a variation coefficient of the mean diameter is not more than 40%.

The mean diameter measured on a circle obtained from a projected area (that is the Heywood diameter) corresponds a diameter of a circle having the same area as the area of the projected figure. For the primary particle, the diameter measured on a circle obtained from a projected area can be determined by means of image analysis of an electron microscopic image, comprising the steps of obtaining a projected area of each primary particle from the electron microscopic image and calculating a diameter of a circle having the same area as the area of the projected area. The variation coefficient of the mean diameter means a percentage obtained by dividing a standard deviation of the diameters of the circles of the projected areas by a mean value of the diameters of the circles of the projected areas.

The fine strontium carbonate powder preferably has a mean diameter (which is measured on a circle obtained from a projected area of a primary particle) of 40 to 80 nm. The variation of a coefficient of the mean diameter is not more than 35%.

The fine strontium carbonate powder of the invention preferably comprises primary particles in essentially cubic or globular form. The primary particles preferably have an aspect ratio (size along the long axis/size along the short axis) of not more than 2. The aspect ratio is determined by a ratio of a longer side to a shorter side of a rectangular square having a smallest area which is drawn in contact with the periphery of the particle.

The fine strontium carbonate powder of the invention comprises primary particles having a diameter smaller than that of the primary particles of the conventional strontium carbonate powder and a substantially uniform size distribution. The fine strontium carbonate powder of the invention is further advantageous, because it can be dispersed in an aqueous medium in the form of essentially primary particles by means of industrially employable dispersing procedures such as an ultrasonic dispersing procedure. In more detail, the fine strontium carbonate powder of the invention generally has a volume-based mean diameter of not more than 120 nm, preferably not more than 100 nm. The volume-based mean diameter can be determined in a dispersion which is prepared by placing 0.2 g of the powder in 20 mL of an aqueous solution containing 0.2 wt. % of sodium hexamethaphosphate and dispersing the powder in the solution for 6 minutes by means of a ultrasonic homogenizer at a power of 17 W according to a dynamic light-scattering method. The volume-based mean diameter generally is 1 to 4 times (specifically 1 to 3 times) as much as the mean diameter measured on a circle obtained from a projected area of a primary particle.

The fine barium carbonate powder of the invention generally has a polymer comprising a polycarboxylic acid or anhydride thereof having a side chain of a polyoxyalkylene group attached to a surface thereof, and has a BET specific surface area of not less than 30 m²/g, in which a primary particle of the powder has a mean diameter of 5 to 50 nm, the mean diameter being measured on a circle obtained from a projected area of a primary particle, and in which a variation coefficient of the mean diameter is not more than 40%.

The fine barium carbonate powder of the invention preferably has a mean diameter in the range of 5 to 30 nm, more preferably in the range of 5 to 25 nm. The mean diameter is measured in the above-mentioned manner. The variation coefficient of the mean diameter preferably is not more than 35%. The BET specific surface area preferably is in the range of 30 to 50 m²/g.

The fine barium carbonate powder of the invention preferably comprises primary particles in essentially cubic or globular form. The primary particles preferably have an aspect ratio (size along the long axis/size along the short axis) of not more than 2.

The fine barium carbonate powder of the invention comprises primary particles having a diameter smaller than that of the primary particles of the conventional barium carbonate powder and a substantially uniform size distribution. The fine barium carbonate powder of the invention is further advantageous, because it can be dispersed in an aqueous medium in the form of essentially primary particles by means of industrially employable dispersing procedures such as an ultrasonic dispersing procedure.

The fine barium carbonate powder of the invention can have a volume-based mean particle diameter of not more than 0.5 μm, preferably not more than 0.3 μm, and can contain particles having a particle diameter of 1 μm or more in an amount of not more than 10 vol. %, preferably not more than 5 vol. %. The volume-based mean particle diameter is obtainable from a volume-based particle diameter distribution which can be determined in a dispersion prepared by placing 0.5 g of the powder in 50 mL of an aqueous solution containing 0.2 wt. % of sodium hexamethaphosphate and dispersing the powder in the solution for 5 minutes by means of a ultrasonic homogenizer at a power of 80 W according to a laser diffraction-scattering method. Thus, the fine barium carbonate powder of the invention contain a less amount of aggregated particles. Therefore, the barium carbonate dispersion shows such a small absorbance as 1.00 or less, particularly in the range of 0.10 to 0.90, at a wavelength of 600 nm. The volume-based mean particle diameter obtained in the above-mentioned manner preferably is 1 to 20 times (specifically 1 to 10 times) as much as the mean diameter measured on a circle obtained from a projected area of a primary particle.

The fine strontium carbonate powder and fine barium carbonate powder according to the invention are very fine and can be well dispersed in an aqueous medium. Therefore, the fine strontium carbonate powder or fine barium carbonate powder of the invention can be easily mixed with other fine inorganic material powder to give a uniform powdery mixture by means of wet-mixing procedures. Accordingly, the highly dispersible fine strontium carbonate powder and barium carbonate powder can be favorably employable for the preparation of a dielectric ceramic powder such as strontium titanate powder and barium titanate powder which are required to have an extremely small size and a uniform composition.

### EXAMPLES

### Example 1

### Preparation of Highly Dispersible Fine Strontium Carbonate Powder

In a 5 L volume Teflon-made reaction vessel, 4,200 g of ion exchanged water and 500 g of strontium hydroxide octahydrates (calcium content: not more than 0.001 wt. %, barium content: not more than 0.001 wt. %, sulfur content: not more than 0.001 wt. %) were placed to prepare an aqueous strontium hydroxide dispersion having a strontium hydroxide content of 4.87 wt. %. To the strontium hydroxide dispersion was added 1.3 g of citric acid monohydrate, and the resulting mixture was stirred at 20° C. for 10 minutes by means of a stirrer to convert it to an aqueous solution. To the resulting dispersion was introduced under stirring gaseous carbon dioxide at a feed rate of 5 L/min. (approx. 22 mL/min., per one gram of strontium hydroxide in the dispersion) to carbonatate strontium hydroxide, resulting in production of strontium carbonate particles. In the course of progress of carbonatation, the dispersion was subjected to pH measurement, and the introduction of gaseous carbon dioxide was stopped when the dispersion showed a pH value less than 7.

The resulting strontium carbonate dispersion was adjusted to have a solid content of 13 wt. %, and pulverized in a media mill (type: AMC 12.5, effective volume: 9.0 L, available from Ashizawa FineTech Co., Ltd.) using zirconium oxide beads (mean size: 300 μm) under such conditions that the amount of charged beads was 80 vol. %, the circumferential speed was 7 m/sec., and a processing period was 60 minutes. At a lapse of 30 minutes of the processing period, a MARIARIM AKM-1511-60 (polycarboxylic acid anhydride having a side chain of a polyoxyalkylene group, available from Nippon Fat and Oil, Co,, Ltd.) was added to the dispersion in an amount of 8 wt. % based on the amount of the solid content in the dispersion.

After the pulverization was complete, the pulverized strontium carbonate dispersion was dried by means of a spray dryer to obtain a fine strontium carbonate powder. The obtained fine strontium carbonate powder had a BET specific surface area of 16.0 m²/g. It was confirmed by observation using FE-SEM (Field Emission Scanning Electra Microscope, S-4800, available from Hitachi High Technologies, Co., Ltd.) that the fine strontium carbonate powder comprised fine particles.

The processing of the FE-SEM image using an image analysis software (MacView ver. 3.5, available from Mountech Co., Ltd.) indicated that a mean diameter measured on a circle obtained from a projected area of a primary particle was 47 nm, a variation coefficient of the mean diameter was 23%, and a mean aspect ratio was 1.25.

The fine strontium carbonate powder was subjected to an analysis on the conditions of its surface using FT-IR according to a one reflection ATE method (diamond 45°, resolution: 4 cm⁻¹). In the analysis, an infrared absorption peak derived from the polymer dispersant comprising polycarboxylic acid anhydride having a side chain of a polyoxyalkylene group was detected, Accordingly, it was confirmed that the fine strontium carbonate powder had the polymer dispersant on its surface.

The volume-based mean diameter of the fine strontium carbonate powder measured by a dynamic diffusing light-scattering method was 92 nm, which was approx. two times as much as the mean diameter (47 nm) measured on a circle obtained from a projected area of a primary particle. Therefore, it was confirmed that the fine strontium carbonate powder had been dispersed in the dispersion as essentially primary particles.

### [Measurement of Volume-Based Mean Diameter According to Dynamic Diffusing Light-Scattering Method]

The fine strontium carbonate powder (0.2 g) and an aqueous solution (20 mL) containing 0.2 wt. % of sodium hexamethaphosphate are placed in a 30 mL-volume glass beaker, and subjected to a dispersing procedure using an ultrasonic homogenizer (BRANSON SONIFIER MODEL S-150d, maximum output power: 75 W, available from Japan Emason, Co., Ltd) for 6 minutes at a power of 17 W. to give a strontium carbonate dispersion. The volume-based particle size distribution of the strontium carbonate particles contained in the dispersion is continuously measured five times (measuring period: one minute) using an apparatus (Nanotrac 150, available Nikkiso Co., Ltd.) for measuring particle size distribution of the particles by a dynamic diffusing light-scattering method. From the obtained mean diameter distribution, the volume-based mean diameter is obtained.

### Example 2

### Preparation of Highly Dispersible Fine Barium Carbonate Powder

In a reaction vessel equipped with a cooler, 3,000 g of pure water was placed. The temperature of the pure water was adjusted to 10° C. To the pure water were added citric acid monohydrate (13.9 g) and barium hydroxide octahydrates (404.8 g) to give an aqueous barium hydroxide dispersion having a barium hydroxide concentration of 6.4 wt. % and a citric acid concentration of 0.37 wt. %.

To the barium hydroxide dispersion (adjusted to 10° C.) was introduced gaseous carbon dioxide at a feed rate of 0.5 L/min. (2.3 mL/min. per one gram of barium hydroxide) under stirring with a polytetrafluoroethylene-made stirrer at 400 r.p.m. until the dispersion showed pH 7.0. Thus, the barium hydroxide was carbonatated to give a barium carbonate dispersion. During the introduction of carbon dioxide, the dispersion was kept at 10° C.

A portion of the obtained barium carbonate dispersion was taken, filtered, washed with water, and dried. The resulting barium carbonate powder had a BET specific surface area of 53.3 m²/g. The observation on the barium carbonate powder by FE-SEM confirmed that the barium carbonate powder comprised acicular particles.

The barium carbonate dispersion was placed in a media mill and pulverized using zirconium oxide beads (mean size: 300 μm) under such conditions that the amount of charged beads was 80 vol. %, the rotor circumferential speed was 7 m/sec., and a processing period was 60 minutes. At a lapse of 30 minutes of the processing period, a MARIARIM AKM-1511-60 (polycarboxylic acid anhydride having a side chain of a polyoxyalkylene group, available from Nippon Fat and Oil, Co., Ltd.) was added to the dispersion in an amount of 8 wt. % based on the amount of the solid content in the dispersion.

After the pulverization was complete, the barium carbonate dispersion was dried in a drum dryer to give a fine barium carbonate powder.

The fine barium carbonate powder was subjected to an analysis on the conditions of its surface using FT-IR according to a one reflection ATR method (diamond 450, resolution: 4 cm⁻¹. In the analysis, an infrared absorption peak derived from the polymer dispersant comprising polycarboxylic acid anhydride having a side chain of a polyoxyalkylene group was detected. Accordingly, it was confirmed that the fine barium carbonate powder had the polymer dispersant on its surface.

It was confirmed by observation using FE-SEM that the fine barium carbonate powder comprised fine particles. The processing of the FE-SEM image using an image analysis software indicated that a mean diameter measured on a circle obtained from a projected area of a primary particle was 30 nm, a variation coefficient of the mean diameter was 20.5%, and a mean aspect ratio was 1.31. The fine barium carbonate powder had a BET specific surface area of 39.3 m²/g.

In a 100 mL-volume glass beaker were placed the fine barium carbonate powder (0.5 g) and an aqueous sodium hexamethaphosphate solution (50 mL, concentration: 0.2 wt. %). The resulting aqueous mixture was subjected to dispersing procedure for 5 minutes by means of an ultrasonic homogenizer (US-300T, available from Nihon Seiki Seisakusho, Co., Ltd., rated output: 300 W, using chip having a diameter of 26 mm) at an output of 80 W (current value: 300 μA), to give a barium carbonate dispersion.

The barium carbonate dispersion was then subjected to measurements of a particle size distribution of the barium carbonate particles in the dispersion and an absorbance. The results were that the mean particle diameter obtained by the volume-based particle size distribution was 0.14 μm, content of particles having a particle size of 1 μm or more was 3.7 vol. %, and the absorbance was 0.80. Therefore, it was confirmed that the dispersion contained uniformly dispersed fine barium carbonate particles.

### [Measurement of Particle Size Distribution]

The barium carbonate dispersion is placed in an apparatus for measuring particle size distribution according to laser-diffraction system (Microtrack Particle Size distribution-Measuring Apparatus 9320 HRA (X-100), available from Nikkiso Co., Ltd.) to measure a volume-based particle size distribution.

### [Measurement of Absorbance]

In a square pillar-type quartz-made cell for measurement of absorbance are placed the barium carbonate dispersion and an aqueous sodium hexamethaphosphate solution (concentration: 0.2 wt. %). The cell is then subjected to measurement of absorbance at a wavelength of 600 nm by means of a spectrophotometer (Spectrophotometer U-2800, available from Hitachi High Technologies, Co., Ltd.). The desired absorbance is obtained by subtracting the absorbance of the aqueous sodium hexamethaphosphate solution (concentration: 0.2 wt. %) from the measured absorbance of the barium carbonate dispersion.

### Comparison Example 1

The procedures of Example 2 were repeated except that the polymer dispersant comprising polycarboxylic anhydride having a side chain of a polyoxyalkylene group was replaced with an ammonium polycarboxylate dispersant (SN Dispersant 5468, available from SunNobco Co., Ltd.), to prepare a barium carbonate powder.

The fine barium carbonate powder was subjected to an analysis on the conditions of its surface using FT-IR according to a one reflection ATR method in the same manner as in Example 2. In the analysis, an infrared absorption peak derived from the ammonium polycarboxylate dispersant was detected. Accordingly, it was confirmed that the fine barium carbonate powder had the ammonium polycarboxylate dispersant on its surface.

The fine barium carbonate powder was observed by FE-SEN. It was confirmed that the fine barium carbonate powder comprised fine particles, The processing of the FE-SEM image using an image analysis software indicated that a mean diameter measured on a circle obtained from a projected area of a primary particle was 30 nm, a variation coefficient of the mean diameter was 22.0%, and a mean aspect ratio was 1.31. The fine barium carbonate powder had a BET specific surface area of 80.0 m²/g.

In a 100 ml-volume glass beaker were placed the fine barium carbonate powder (0.5 g) and an aqueous sodium hexamethaphosphate solution (50 mL, concentration: 0.2 wt. %). The resulting aqueous mixture was subjected to dispersing procedure in the same manner as in Example 2 to give a barium carbonate dispersion.

The barium carbonate dispersion was then subjected to measurements of a particle size distribution of the barium carbonate particles in the dispersion and an absorbance in the same manner as in Example 2. The results were that the mean particle diameter obtained by the volume-based particle size distribution was 9.87 μm, content of particles having a particle size of 1 μm or more was 100 vol. %, and the absorbance was 1.70. Therefore, it was confirmed that the dispersion contained aggregated fine barium carbonate particles.

What is claimed is:

1. A process for preparing a fine alkaline earth metal carbonate powder showing high dispersibility, the alkaline earth metal carbonate being selected from the group consisting of strontium carbonate and barium carbonate, which comprises the steps of pulverizing a powder of strontium carbonate or barium carbonate in an aqueous medium using ceramic beads having a mean diameter of 10 to 1,000 μm in the presence of a polymer comprising a polycarboxylic acid or anhydride thereof having a side chain of a polyoxyalkylene group, and drying the pulverized powder.

2. The process of claim 1, in which the polymer comprises a polycarboxylic acid anhydride having a side chain of a polyoxyalkylene group.

3. The process of claim 2, in which the polycarboxylic acid anhydride is a maleic anhydride polymer.

4. The process of claim 1, in which the alkaline earth metal carbonate powder is a strontium carbonate powder which is prepared by supplying gaseous carbon dioxide into an aqueous solution or dispersion containing strontium hydroxide in an amount of 1 to 20 wt. % and an organic acid or a salt thereof in an amount of 0.012 to 24 wt. % based on the amount of strontium hydroxide, under stirring at a temperature of 2 to 100° C., at a supply rate of 0.5 to 200 mL/min., per 1 g of the strontium hydroxide, whereby carbonatating the strontium hydroxide to produce the strontium carbonate powder.

5. The process of claim 1, in which the alkaline earth metal carbonate powder is a barium carbonate powder which is prepared by supplying gaseous carbon dioxide into an aqueous dispersion containing barium hydroxide in an amount of 3 to 20 wt. % and an citric acid in an amount of 3.5 to 12 wt. % based on the amount of barium hydroxide under stirring at a temperature of 5 to 15° C., at a supply rate of 0.5 to 20 mL/min., per 1 g of the barium hydroxide, whereby carbonatating the barium hydroxide to produce the barium carbonate powder.

6. A fine strontium carbonate powder showing high dispersibility which has a polymer comprising a polycarboxylic acid or anhydride thereof having a side chain of a polyoxyalkylene group attached to a surface thereof, in which a primary particle of the powder has a mean diameter of 30 to 90 nm, the mean diameter being measured on a circle obtained from a projected area of a primary particle, and in which a variation coefficient of the mean diameter is not more than 40%.

7. The fine strontium carbonate powder of claim 6, in which the mean diameter is in the range of 40 to 80 nm.

8. The fine strontium carbonate powder of claim 6, in which the variation coefficient of the mean diameter is not more than 35%.

9. The fine strontium carbonate powder of claim 6, in which a mean value of an aspect ratio of the primary particle is not more than 2.

10. The fine strontium carbonate powder of claim 6, which has a volume-based mean diameter of not more than 120 nm, the volume-based mean diameter being determined in a dispersion which is prepared by placing 0.2 g of the powder in 20 mL of an aqueous solution containing 0.2 wt. % of sodium hexamethaphosphate and dispersing the powder in the solution for 6 minutes by means of a ultrasonic homogenizer at a power of 17 W according to a dynamic light-scattering method.

11. A fine barium carbonate powder showing high dispersibility which has a polymer comprising a polycarboxylic acid or anhydride thereof having a side chain of a polyoxyalkylene group attached to a surface thereof, which has a BET specific surface area of not less than 30 m²/g, in which a primary particle of the powder has a mean diameter of 5 to 50 nm, the mean diameter being measured on a circle obtained from a projected area of a primary particle, and in which a variation coefficient of the mean diameter is not more than 40%.

12. The fine barium carbonate powder of claim 11, in which the BET specific surface area is in the range of 30 to 50 m²/g.

13. The fine barium carbonate powder of claim 11, in which a mean value of an aspect ratio of the primary particle is not more than 2.

14. The fine barium carbonate powder of claim 11, in which a volume-based mean particle diameter is not more than 0.5 μm and a content of particles having a particle diameter of 1 μm or more is not more than 10 vol. %, the volume-based mean particle diameter being obtainable from a volume-based particle diameter distribution which is determined in a dispersion prepared by placing 0.5 g of the powder in 50 mL of an aqueous solution containing 0.2 wt. % of sodium hexamethaphosphate and dispersing the powder in the solution for 5 minutes by means of a ultrasonic homogenizer at a power of 80 W according to a laser diffraction-scattering method.

15. The fine barium carbonate powder of claim 11, in which a dispersion prepared by placing 0.5 g of the powder in 50 mL of an aqueous solution containing 0.2 wt. % of sodium hexamethaphosphate and dispersing the powder in the solution for 5 minutes by means of a ultrasonic homogenizer at a power of 80 W shows an absorbance of 1.00 or less at a wavelength of 600 nm.
